(19) United States
(12) Patent Application Publication
(10) Pub. No.: US 2025/0322435 A1
(43) Pub. Date: Oct. 16, 2025

(54) METHOD FOR ACQUIRING CONDITIONAL ADDITIONAL INCOME

(71) Applicant: Steven Craig Boileau, Victoria (CA)

(72) Inventor: Steven Craig Boileau, Victoria (CA)

(21) Appl. No.: 19/252,429

(22) Filed: Jun. 27, 2025

Related U.S. Application Data
(63) Continuation-in-part of application No. 18/376,227, filed on Oct. 3, 2023.

(51) Int. Cl. G06Q 30/04; G06Q 40/02; G06Q 40/04

(52) U.S. Cl. CPC G06Q 30/04; G06Q 40/02; G06Q 40/04; G06Q 2230/00

(57) ABSTRACT

A method comprising the steps of: publishing an original post by an author; investing a predetermined amount of money by an investor; selecting a percentage by the investor; upvoting the original post by a plurality of voters; and taking actions after expiration of an escrow duration. A system is configured to perform functions to: publish an original post by an author; invest a predetermined amount of money by an investor; select a percentage by the investor, upvote the original post by a plurality of voters; and take actions after expiration of an escrow duration.

### CROSS-REFERENCE TO RELATED APPLICATIONS

This Patent Application is a Continuation-in-Part Patent Application of a pending application Ser. No. 18/376,227 filed on Oct. 3, 2023. The entire Disclosure made in the pending application Ser. No. 18/376,227 is hereby incorporated by reference.

### FIELD OF THE INVENTION

This invention relates generally to a method for acquiring conditional additional income. More particularly, the present invention relates to the method for acquiring conditional additional income including online voting processes.

### BACKGROUND OF THE INVENTION

The pending application Ser. No. 18/376,227 discloses mentation faculty and provides an application that offers financial distribution, and allowing interested members to finance private or public authors and their mentation faculty.

The instant disclosure provides a method for acquiring conditional additional income. After expiration of an escrow duration, actions may include distribution of a percentage of a predetermined amount of money to an author; distribution of a remaining amount of the predetermined amount of money to a plurality of voters; and issuance of predetermined shares of right of an original post to an investor.

### SUMMARY OF THE INVENTION

A method for acquiring conditional additional income. The method comprises the steps of: publishing an original post by an author; investing a predetermined amount of money by an investor; selecting a percentage by the investor; upvoting the original post by a plurality of voters; and taking actions after expiration of an escrow duration.

A system is configured to perform functions to: publish an original post by an author; invest a predetermined amount of money by an investor; select a percentage by the investor; upvote the original post by a plurality of voters; and take actions after expiration of an escrow duration.

### BRIEF DESCRIPTION OF THE DRAWINGS

FIG. 1 is a flowchart of a method to acquire conditional additional income in examples of the present disclosure.

FIG. 2 shows a system in examples of the present disclosure.

FIG. 3 shows a drop down list in examples of the present disclosure.

FIG. 4 is another flowchart of a method to acquire conditional additional income in examples of the present disclosure.

FIG. 5 shows a display screen in examples of the present disclosure.

### DETAILED DESCRIPTION OF THE INVENTION

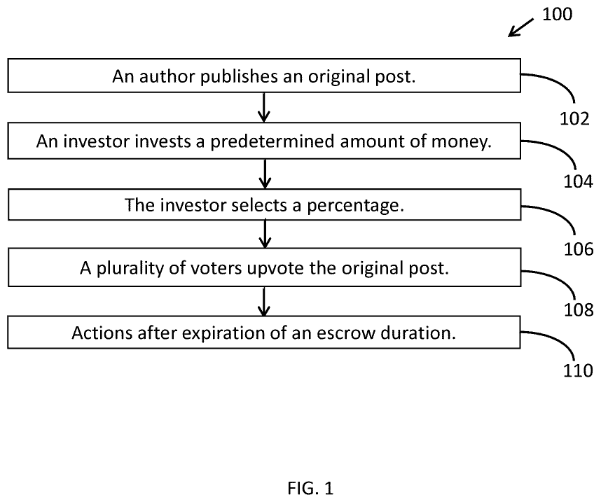

FIG. 1 is a flowchart of a method 100 to acquire conditional additional income in examples of the present disclosure. The Method 100 may start from block 102.

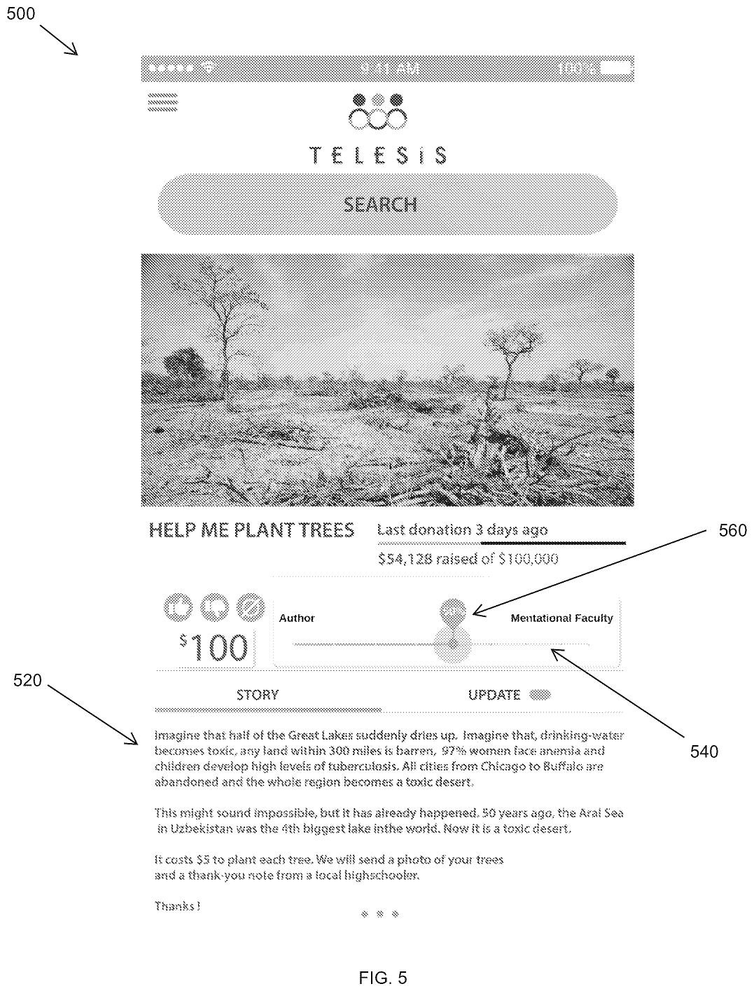

In block 102, referring now to FIG. 5, an author publishes an original post 520. FIG. 5 shows a display screen 500 in examples of the present disclosure. In one example, the display screen 500 is a cell phone display screen. In another example, the display screen 500 is a laptop display screen. In still another example, the display screen 500 is a monitor. In examples of the present disclosure, the original post 520 may include a story.

In examples of the present disclosure, the instant disclosure is applicable to any datum at any syntactic exponential gradient or formulae, on worldwide web or application that has an “upvote” or positive “vote” of confidence on any original posts or authored piece of syntax that also has a vote in support of the piece. Any visiting or viewed interested investor or financier may contribute to the effect of promoting critical integrity and stimulating it in motion and notion. Block 102 may be followed by block 104.

In block 104, an investor invests a predetermined amount of money. In examples of the present disclosure, the predetermined amount of money is kept in an escrow account. In one example, the predetermined amount of money is USD $100. In another example, the predetermined amount of money is USD $1,000. In still another example, the predetermined amount of money is USD $10,000. Block 104 may be followed by block 106.

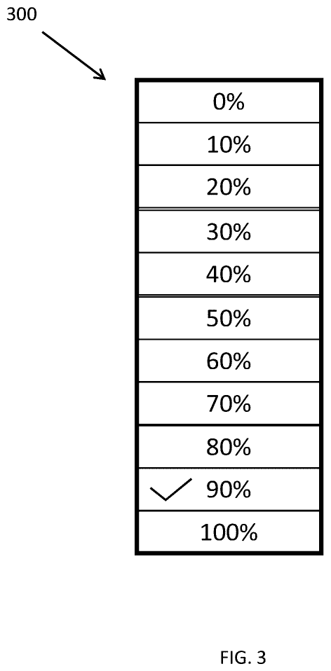

In block 106, referring now to FIGS. 3 and 5, the investor selects a percentage. In examples of the present disclosure, the investor selects a percentage from a drop down list 300 of FIG. 3. In one example, the investor selects 90%. In examples of the present disclosure, the investor selects a percentage from a slider scale 540 of FIG. 5. In one example, a marker 560 representing the investor's selected percentage is 50%. Block 106 may be followed by block 108.

In block 108, a plurality of voters upvote the original post. In one example, the plurality of voters are 10 persons. In another example, the plurality of voters are 100 persons. In still another example, the plurality of voters are 1,000 persons.

In examples of the present disclosure, a marker 560 of FIG. 5 on the slider scale 540 representing the percentage moves along a first direction by a distance determined by a count of the plurality of voters. In one example, the marker 560 moves toward left (decreasing percentage) by 1% for every 100 voters upvote the original post. In another example, the marker 560 moves toward left (decreasing percentage) by 1% for every 1,000 voters upvote the original post. Block 108 may be followed by block 110.

In block 110, actions take place after expiration of an escrow duration. In one example, the escrow duration is 10 days. In another example, the escrow duration is 30 days. In still another example, the escrow duration is 90 days. After expiration of the escrow duration, the actions may include distribution of the percentage of the predetermined amount of money to the author; distribution of a remaining amount of the predetermined amount of money to the plurality of voters (so that each of the plurality of voters acquires conditional additional income); and issuance of predetermined shares of right of the original post to the investor.

In one example, the investor invests USD $1,000 as the predetermined amount of money and selects 90% as the percentage. The original post is estimated to have an initial value of USD $9,000. 10 voters upvote the original post during the escrow duration. After expiration of the escrow duration, the actions may include distribution of the percentage (90%) of the predetermined amount of money (USD $1,000) to the author; distribution of a remaining amount (USD $100) of the predetermined amount of money (USD $1,000) to the plurality of voters (so that each of the plurality of voters acquires conditional additional income); and issuance of predetermined shares of right (10%) of the original post to the investor. The author receives USD $900, that is, 0.9×USD $1,000. Each of the voters receives USD $10, that is, USD $100/10. The investor receives 10% shares of right of the original post, that is, USD $900/USD $9,000.

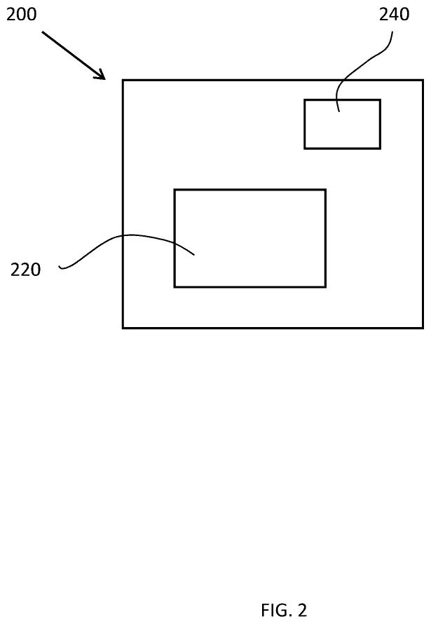

FIG. 2 shows a system 200 in examples of the present disclosure. The system 200 comprises a control unit 220 and a non-transitory computer-readable storage medium 240 storing instructions.

The system 200 is configured to perform functions to: publish an original post by an author; invest a predetermined amount of money by an investor; select a percentage by the investor; upvote the original post by a plurality of voters; and take actions after expiration of an escrow duration.

The non-transitory computer-readable storage medium 240 storing instructions that, when executed by one or more processors of the control unit 220, cause the control unit 220 to perform the steps of: publishing an original post by an author; investing a predetermined amount of money by an investor; selecting a percentage by the investor; upvoting the original post by a plurality of voters; and taking actions after expiration of an escrow duration.

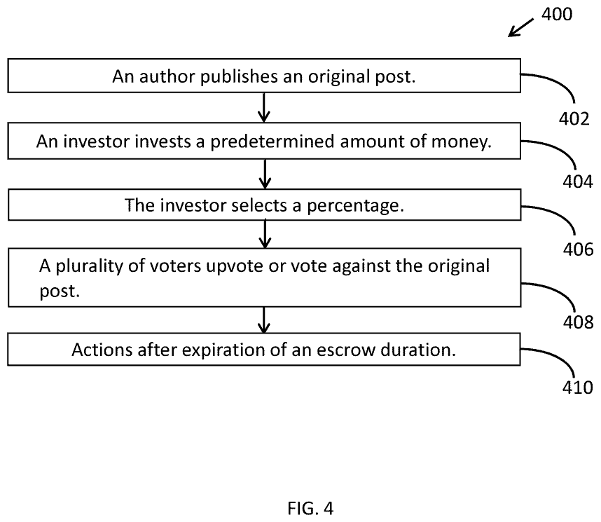

FIG. 4 is a flowchart of a method 400 to acquire conditional additional income in examples of the present disclosure. The method 400 of FIG. 4 is similar to the method 100 of FIG. 1 except that voting against the original post is added to block 408 (also affects actions in subsequent block 410). The Method 400 may start from block 402.

In block 402, referring now to FIG. 5, an author publishes an original post 520. FIG. 5 shows a display screen 500 in examples of the present disclosure. In one example, the display screen 500 is a cell phone display screen. In another example, the display screen 500 is a laptop display screen. In still another example, the display screen 500 is a monitor. In examples of the present disclosure, the original post 520 may include a story. Block 402 may be followed by block 404.

In block 404, an investor invests a predetermined amount of money. In examples of the present disclosure, the predetermined amount of money is kept in an escrow account. In one example, the predetermined amount of money is USD $100. In another example, the predetermined amount of money is USD $1,000. In still another example, the predetermined amount of money is USD $10,000. Block 404 may be followed by block 406.

In block 406, referring now to FIGS. 3 and 5, the investor selects a percentage. In examples of the present disclosure, the investor selects a percentage from a drop down list 300 of FIG. 3. In one example, the investor selects 90%. In examples of the present disclosure, the investor selects a percentage from a slider scale 540 of FIG. 5. In one example, a marker 560 representing the investor's selected percentage is 50%. Block 406 may be followed by block 408.

In block 408, a plurality of voters upvote or vote against the original post. In one example, the plurality of voters are 10 persons. In another example, the plurality of voters are 100 persons. In still another example, the plurality of voters are 1,000 persons.

In examples of the present disclosure, a marker 560 of FIG. 5 on the slider scale 540 representing the percentage moves along a first direction by a distance determined by a count of up-voters. The marker 560 moves along a second direction opposite the first direction by a distance determined by a count of voters vote against the original post. The marker 560 oscillates. In examples of the present disclosure, the marker 560 moves toward left (decreasing percentage) by 1% for every 100 voters upvote the original post and moves toward right (increasing percentage) by 0.1% for every 100 voters upvote. In one example, the decreasing percentage rate is larger than the increasing percentage rate (for example, 1% for every 100 voters is larger than 0.1% for every 100 voters). In another example, the decreasing percentage rate equals to the increasing percentage rate. Block 408 may be followed by block 410.

In block 410, actions take place after expiration of an escrow duration. In one example, the escrow duration is 10 days. In another example, the escrow duration is 30 days. In still another example, the escrow duration is 90 days. After expiration of the escrow duration, if a number of upvotes is smaller than a number of against votes, the percentage of the predetermined amount of money will not be distributed to the author. The percentage of the predetermined amount of money will be refunded to the investor.

In one example, the investor invests USD $1,000 as the predetermined amount of money and selects 90% as the percentage. The original post is estimated to have an initial value of USD $9,000. 10 voters upvote the original post during the escrow duration. 15 voters vote against the original post during the escrow duration. After expiration of the escrow duration, because a number of upvotes (10 votes) is smaller than a number of against votes (15 votes), the percentage (90%) of the predetermined amount of money (USD $1,000) will be returned to the investor rather than the author. The 25 voters share USD $900, that is, 0.1×USD $9,000. Each of the 25 voters receives USD $36. In examples of the present disclosure, only voters vote against the original post, when the number of upvotes is smaller than the number of against votes, will receive distribution. In this case, each of the 15 voters receives USD $60.

Those of ordinary skill in the art may recognize that modifications of the embodiments disclosed herein are possible. For example, a selected percentage may vary. Other modifications may occur to those of ordinary skill in this art, and all such modifications are deemed to fall within the purview of the present invention, as defined by the claims.

1. A method for acquiring conditional additional income, the method comprising the steps of:
publishing an original post by an author;
investing a predetermined amount of money by an investor, the predetermined amount of money being kept in an escrow account;
selecting a percentage by the investor;
upvoting the original post by a plurality of voters; and
after expiration of an escrow duration,
the percentage of the predetermined amount of money being distributed to the author;
a remaining amount of the predetermined amount of money being distributed to the plurality of voters; and
the investor receiving predetermined shares of right of the original post.

2. The method of claim 1, wherein the step of selecting the percentage by the investor comprises the sub-step of:
selecting the percentage from a drop down list.

3. The method of claim 1, wherein the step of selecting the percentage by the investor comprises the sub-step of:
selecting the percentage from a slider scale.

4. The method of claim 3, wherein a marker on the slider scale representing the percentage moves along a first direction by a distance determined by a count of the plurality of voters.

5. A system comprising:
a control unit;
wherein the system is configured to perform functions to:
publish an original post by an author;
invest a predetermined amount of money by an investor, the predetermined amount of money being kept in an escrow account;
select a percentage by the investor;
upvote the original post by a plurality of voters; and
after expiration of an escrow duration,
the percentage of the predetermined amount of money is distributed to the author;
a remaining amount of the predetermined amount of money is distributed to the plurality of voters; and
the investor receives predetermined shares of right of the original post.

6. The system of claim 5, wherein to select the percentage by the investor comprises the sub-step of:
selecting the percentage from a drop down list.

7. The system of claim 5, wherein to select the percentage by the investor comprises the sub-step of:
selecting the percentage from a slider scale.

8. The system of claim 7, wherein a marker on the slider scale representing the percentage moves along a first direction by a distance determined by a count of the plurality of voters.

9. A non-transitory computer-readable storage medium storing instructions that, when executed by one or more processors of a control unit, cause the control unit to perform the steps of:
publishing an original post by an author;
investing a predetermined amount of money by an investor, the predetermined amount of money being kept in an escrow account;
selecting a percentage by the investor;
upvoting the original post by a plurality of voters; and
after expiration of an escrow duration,
the percentage of the predetermined amount of money being distributed to the author;
a remaining amount of the predetermined amount of money being distributed to the plurality of voters; and
the investor receiving predetermined shares of right of the original post.

10. The non-transitory computer-readable storage medium of claim 9, wherein the step of selecting the percentage by the investor comprises the sub-step of:
selecting the percentage from a drop down list.

11. The non-transitory computer-readable storage medium of claim 9, wherein the step of selecting the percentage by the investor comprises the sub-step of:
selecting the percentage from a slider scale.

12. The non-transitory computer-readable storage medium of claim 11, wherein a marker on the slider scale representing the percentage moves along a first direction by a distance determined by a count of the plurality of voters.
